(19) United States
(12) Patent Application Publication
(10) Pub. No.: US 2019/0069221 A1
(43) Pub. Date: Feb. 28, 2019

(54) SYSTEMS AND METHODS FOR MACHINE-TYPE COMMUNICATION

(71) Applicant: Definition Networks, Inc., Middleton, MA (US)

(72) Inventors: Kenneth E. Virgile, Lexington, MA (US); Sundar R. Ramaswamy, Bangalore (IN)

(73) Assignee: Definition Networks, Inc., Middleton, MA (US)

(21) Appl. No.: 16/112,290

(22) Filed: Aug. 24, 2018

(30) Foreign Application Priority Data
Aug. 31, 2017 (IN) 201711030961

(51) Int. Cl. H04W 48/14; H04W 4/80; H04W 4/70; H04W 88/16; H04W 76/12

(52) U.S. Cl. CPC H04W 48/14; H04W 4/80; H04W 84/18; H04W 88/16; H04W 76/12; H04W 4/70

(57) ABSTRACT

Systems and methods are provided for managing machine-type communication. The disclosed systems include a cellular network with a intermediary point that communicates with an application entity and machine-type communication (MTC) devices. The intermediary point can retrieve connection information for devices with low-power wide-area modems from a non-transitory memory of the augmented cellular network. The intermediary point can also provide the retrieved connection information to application entities.

### CROSS-REFERENCE TO RELATED APPLICATION

The present application claims priority under 35 U.S.C. § 119 to Indian Patent Application No. 201711030961, filed Aug. 31, 2017, the disclosure of which is incorporated herein by reference in its entirety.

### TECHNICAL FIELD

The disclosed embodiments generally relate to machine-type communication over cellular networks, and more specifically, to enhancing cellular networks with addressing and interworking functionality for managing low-power wide-area devices on cellular networks.

### SUMMARY

The disclosed systems and methods improve upon existing approaches for integrating devices from a Wireless Sensor Network (WSN) into a cellular network by enhancing the functionality of the cellular network, without burdening cellular network operators or application entity service providers with additional equipment requirements. In particular, the disclosed systems and methods provide additional functionality otherwise unavailable when using low-power, wide-area networking protocols with Machine Type Communications (MTC) devices that are directly connected to a cellular network. For example, the disclosed systems and methods enable existing Internet of Things (IoT) protocols like Message Queue Telemetry Transport for Sensor Networks (MQTT-SN), IPv6 over Low-Power Wireless Personal Area Networks (6LoWPAN) and Open Mobile Alliance Lightweight Machine to Machine (OMA LWM2M) protocols to work over NarrowBand IoT (NB-IoT) networks, or similar networks for low-power, wide-area devices.

Consequently, MTC devices need not change software protocols or require additional gateways when updating MTC devices to connect directly to the cellular network (e.g., when replacing WSN modems with NB-IoT modems that connect directly to the cellular network). The disclosed systems and methods can also enable MTC devices and application entities to continue using existing addresses, without needing modification to support 3GPP addressing. Furthermore the disclosed systems and methods encompass interworking between different device management protocols, including the management of devices not participating in the device management protocol used by a device management server.

Accordingly, in some embodiments, the disclosed systems for managing machine-type communication can include a cellular network having an intermediary point that communicates with an application entity and MTC devices. The intermediary point can receive data from a first low-power wide-area MTC device and provide the data to an application entity. The intermediary point can receive data from an application entity and provide the data to the first MTC device. The intermediary point can also transfer the data between the first MTC device and a gateway, where the gateway shares responsibility for the communication between the application entity and the MTC device.

In various aspects, the intermediary point can determine that a second MTC device of the MTC devices is attempting to connect to the cellular network. Based at least in part on this determination, the intermediary point can transfer data from the second MTC device to the application entity, and from the application entity to the second MTC device. In some aspects, the intermediary point can select some of the MTC devices based at least in part on status information stored in the non-transitory memory of the intermediary point, and can transfer data from the application entity to multiple MTC devices.

In some aspects, the intermediary point can communicate with the MTC devices that are using NB-IoT, and wherein the MTC devices are using at least one of MQTT-SN and 6LoWPAN.

In various aspects, the intermediary point can receive a request from the first MTC device to connect to a cellular network. According to the embodiments detailed below, this cellular network can be augmented to allow communication between MTC devices and one or more application entities. In this manner, the cellular network can be an “augmented cellular network.”

The intermediary point can provide connection information to the first MTC device during the establishment of the connection to the augmented cellular network. In some aspects, providing the connection information to the first MTC device can include conveying the connection information from a Service Capability Exposure Function (SCEF) to a Mobility Management Entity (MME) using a T6 protocol. In some aspects, providing the connection information to the first MTC device can include conveying the connection information from a gateway for a Packet Data Network (PDN), i.e., a PDN Gateway (PGW) to a Serving Gateway (SGW) using a General Packet Radio Service (GPRS) Tunneling Protocol (GTP).

Furthermore, in some embodiments, the disclosed systems for managing machine-type communication can include a cellular network with an intermediary point that communicates with an application entity and MTC devices. The intermediary point can serve as an interface controller for the devices using a protocol typically running over a WSN. In some aspects, the WSN protocol can be 6LoWPAN, and the intermediary point acts as a 6LoWPAN border router for the devices. In various aspects, the protocol can be MQTT-SN, and the intermediary point can serve as a transparent MQTT-SN gateway or an aggregating MQTT-SN gateway. In some aspects, the intermediary point can copy and forward messages received from the application entity destined for multiple NB-IoT devices, thereby enabling broadcast communication between the application entity and the MTC devices. The intermediary point can be implemented by at least one of a PGW, Cellular IoT Serving Gateway Node (C-SGN), and SCEF node.

Additionally, in some embodiments, the disclosed systems for managing machine-type communication can include a cellular network with an intermediary point that communicates with an application entity and MTC devices. The intermediary point can serve as an interworking component for MTC devices associated with the application entity. In some aspects, the intermediary point can receive one or more messages in an Open Mobile Alliance Device Management (OMA DM) protocol running over Hypertext Transfer Protocol (HTTP) from the application entity, convert the received messages into messages in an OMA LWM2M protocol running over Constrained Application Protocol (CoAP), and send the converted messages to one or more MTC devices. In some aspects, the intermediary point can serve as a device management server, the device management server comprising least one of an OMA DM server and an OMA LWM2M server. In various aspects, the intermediary point can expose a device management layer to the application entity for accessing the functionality of the device management server. The intermediary point can be implemented by at least one of a PGW, C-SGN, and SCEF node.

Additionally, in some embodiments, the disclosed systems for managing machine-type communication can include a cellular network with an intermediary point that communicates with an application entity and MTC devices. The intermediary point can receive messages from the application entity, use the first addresses in the messages to derive second addresses, and route the messages to the MTC devices according to the second addresses. In some aspects, the second addresses may not be 3GPP addresses. In various aspects, the first address can be external addresses of the MTC devices and the second addresses can be identifiers of connections within the cellular network to reach cellular network components with radio transmitters to the MTC devices. In various aspects, the intermediary point can use the first addresses to obtain the second addresses using a stored association between the first addresses and the second addresses. At least one of a modified T6 interface of the cellular network and modified GTP of the cellular network can enable routing of non-3GPP address to the MTC devices. In various aspects, the intermediary point determines the second address by performing protocol analysis of the messages from the MTC devices. In various aspects, the second addresses can be either MQTT-SN addresses or 6LoWPAN addresses. The intermediary point can be implemented by at least one of a PGW, C-SGN, and SCEF node.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings are not necessarily to scale or exhaustive. Instead, emphasis is generally placed upon illustrating the principles of the inventions described herein. These drawings, which are incorporated in and constitute a part of this specification, illustrate several embodiments consistent with the disclosure and, together with the detailed description, serve to explain the principles of the disclosure. In the drawings:

FIG. 1A depicts an exemplary functional schematic of a WSN that connects MTC devices to an application entity using a cellular network.

FIG. 1B depicts an exemplary functional schematic of MTC devices directly connected to the cellular network without a WSN.

FIG. 2 depicts an exemplary functional schematic of MTC devices directly connected to an augmented cellular network.

FIG. 3 depicts an exemplary schematic of an augmented cellular network.

FIG. 4 depicts an exemplary realization of the intermediary point component as a virtual network function.

### DETAILED DESCRIPTION

Reference will now be made in detail to exemplary embodiments as with reference to the accompanying drawings. In some instances, the same reference numbers will be used throughout the drawings and the following description to refer to the same or like parts. These embodiments are described in sufficient detail to enable those skilled in the art to practice the disclosed embodiments and it is to be understood that other embodiments may be utilized and that changes may be made without departing from the scope of the disclosed embodiments. For example, components of the disclosed exemplary systems and apparatuses may be combined or separated into subcomponents without departing from the scope of the disclosed embodiments. The following detailed description, therefore, is not to be interpreted in a limiting sense.

The following detailed description incorporates by reference in their entirety 3GPP TR 37.868 V11.0.0, released September 2011; 3GPP TR 23.888 V11.0.0, released September 2012; 3GPP TR 23.720 V13.0.0, released March 2015; 3GPP TS 29.368 V13.1.0, released September 2015; 3GPP TS 123.002 V13.6.0, released June 2016; 3GPP TS 23.682 V13.6.0, released June 2016; 3GPP TS 32.240 V13.2.0, released June 2016; and 3GPP TS 23.203 V13.8.0, released June 2016. 3GPP TS 23.401 Version 14.1.0, released September 2016; 3GPP TS 23.682 Version 14.1.0, released September 2016. These incorporated specifications are collective referred to herein as the “3GPP Specifications.”

The following detailed description further incorporates by reference in their entirety Internet Engineering Task Force (IETF) Request for Comments (RFC) 4919, titled “IPv6 over Low-Power Wireless Personal Area Networks (6LoWPANs): Overview, Assumptions, Problem Statement, and Goals”; IETF RFC 4944, titled “Transmission of IPv6 Packets over IEEE 802.15.4 Networks”; IETF RFC 6282, titled “Compression Format for IPv6 Datagrams over IEEE 802.15.4-Based Networks”; IETF RFC 6568, titled “Design and Application Spaces for IPv6 over Low-Power Wireless Personal Area Networks (6LoWPANs)”; IETF RFC 6606, titled “Problem Statement and Requirements for IPv6 over Low-Power Wireless Personal Area Network (6LoWPAN) Routing”, IETF RFC 6775, entitled “Neighbor Discovery Optimization for IPv6 over Low-Power Wireless Personal Area Networks (6LoWPANs).” These incorporated specifications are collectively referred to herein as the “6LoWPAN Specifications.”

The following detailed description further incorporates by reference in its entirety MQTT for Sensor Networks, Protocol Specification, Version 1.2, released November 2013, referred to herein as the “MQTT-SN Specifications.”

The following detailed description further incorporates by reference in their entirety Lightweight Machine to Machine Technical Specification Candidate Version 1.0; OMA Device Management Protocol Approved Version 2.0; and Management Interface for M2M Requirements Approved Version 1.0, referred to herein as the “LWM2M Specifications.”

As used herein, “MTC” refers to machine-type communication. Such communication can involve transmission of messages between components of the IoT, such as sensors, devices, machines, applications, or servers. For example, machine-type communications may involve applications such as environmental monitoring, infrastructure management, energy management, medical or healthcare systems, and transportation. Specific, non-limiting examples of machine-type communications may include smart electrical meters reporting electrical usages; instructions to manage electrical distribution equipment; scheduling and status information from transportation vehicles, such as buses, and/or alarms or status information from security systems. MTC can involve data or instructions. MTC can involve broadcasting the same message, or similar messages (e.g., messages configured to generate the same effect in an MTC termination point), to multiple MTC endpoints.

As used herein, “MTC device” refers to a termination point for machine-type communication. Non-limiting examples of MTC devices include embedded devices, such as smart electrical meters that report electrical power usage periodically; vehicles, such as a buses or taxis, configured to report location and service status periodically; and mobile devices, such as smartphones, tablets, laptop computers, or similar devices configured with an application that reports contextual information, such as location and device state. As would be appreciated by one of skill in the art, many other devices can serve as termination points for machine-type communication, and the above examples are not intended to be limiting.

As used herein, “application entity” describes a termination point for machine-type communication. Application entities can include one or more computing devices configured to receive instructions and/or information from MTC devices. In some embodiments, an application entity can include one or more physical or virtual servers hosting one or more application servers. The application servers may be configured to host one or more applications. These applications may be configured to communicate with MTC devices. In some aspects, application entities can interact with MTC devices using device management protocols, such as the OMA DM protocol or the OMA LWM2M protocol. These protocols may run over different stacks. For example, the OMA DM protocol can run over HTTP while the OMA LWM2M can run over CoAP. Device management servers can also be implemented, together with interfaces enabling applications to access these device management servers, such as the OMA Data Management (DM) Layer.

Non-limiting examples of application entities consistent with disclosed embodiments include a security service hosted on a cloud computing platform that receives status information from security system devices, an internet-connected workstation running a process control application that provides control instructions to process control systems at a manufacturing facility, and a mobile application configured to receive location information from signaling devices affixed to personal belongings such as key chains and wallets. One of skill in the art would recognize that many other applications using many other combinations of hardware and/or software can implement the disclosed embodiments.

As used herein, “WSN” refers to a wireless sensor network. A WSN can include one or more MTC devices that are configured to provide data to one or more application entities. In some aspects, the MTC devices of a WSN can be spatially distributed. A WSN can support communications between MTC devices and application entities using Low Power Wide Area Network (LPWAN) technology. Examples of such LPWAN technology include SIGFOX, LoRA, DASH7, NB-Fi, NWave, RPMA, Weightless, and similar LPWAN technologies. In some embodiments, these LPWAN technologies may provide services up to the link level in the Open Systems Interconnection model, and the link layer in the Internet Protocol suite. In some embodiments, a WSN can run transport layer protocols (e.g., Transmission Control Protocol (TCP), User Datagram Protocol (UDP), short message service (SMS)) and network layer protocols (e.g., Internet Protocol (IP) or 6LoWPAN) over these LPWAN technologies. In some embodiments, a WSN can run higher or application layer protocols over these lower level protocols, such as HTTP, CoAP, Message Queue Telemetry Transport (MTTQ) and MTTQ-SN. A WSN can provide different functionality depending on the choice of protocols. For example, MTC devices using the Gateway Discovery procedure of MQTT-SN use broadcast messages, and the WSN would provide broadcast functionality. Furthermore, MTC devices may require an interworking device, such as a MQTT-SN gateway or 6LoWPAN border router, to communicate with application entities that do not use the same protocols. Furthermore, MTC devices may be controlled using a device management protocol running over a protocol stack incompatible with the protocol stack of the application entity. For example, an application entity running an OMA DM application may provide commands using an HTTP request to MTC devices reachable using a cellular network. In some aspects, an adapter can be configured to convert this OMA DM request to an OMA LWM2M request running over CoAP, for MTC devices that support OMA LWM2M but not OMA DM. An intermediary point of the cellular network can convert this OMA DM request into one or more OMA LWM2M messages for one or more MTC devices. A 6LoWPAN border router or similar device may be configured to route these messages to the one or more MTC devices using 6LoWPAN as a protocol.

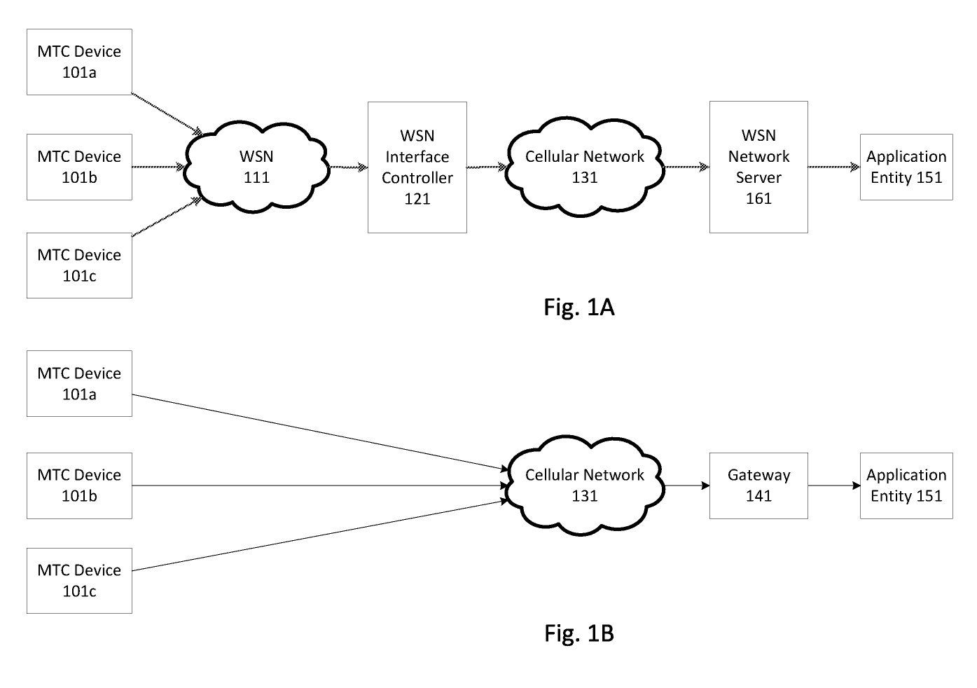

FIG. 1A depicts an exemplary functional schematic of a WSN 111 that connects MTC devices (e.g., MTC Device 101a) to Application Entity 151 using cellular network 131. WSN 111 includes a WSN Interface Controller 121. Among other functions, WSN Interface Controller 121 can encapsulate the MTC device payloads with the address of WSN Network Server 161, so that the cellular network can route messages to WSN Network Server 161. Among other functions, WSN Network Server 161 can remove the encapsulation and deliver the messages to Application Entity 151. Some embodiments may not require WSN Network Server, because WSN Interface Controller 121 can be configured with open interfaces capable of communicating with Application Entity 151 without using a WSN network server. For example, when WSN 111 uses the 6LoWPAN protocol, WSN Interface Controller 121 can include 6LoWPAN border router functionality. As an additional example, when the WSN 111 uses LoRa technology, WSN Interface Controller 121 can include LoRa gateway/concentrator functionality, and WSN Network Server 161 can include LoRa network server functionality.

According to this implementation, one or more machine-type devices (e.g., MTC Device 110a, MTC Device 110b, MTC Device 110c) can communicate over a WSN (e.g., WSN 111) with WSN Interface Controller 121. This WSN Interface Controller 121 can be configured to manage connections between WSN 111 and Cellular Network 131. For example, WSN Interface Controller 121 can be configured to transmit and receive cellular network signals. As an additional example, WSN Interface Controller 121 can be configured to convert messages from a protocol used for WSNs to a protocol used for transmissions over the cellular network. WSN Interface Controller 121 can be configured to send the converted message over the cellular network to WSN Network Server 161. WSN Network Server 161 can be configured to send the message to Application Entity 151. Likewise, Application Entity 151 can be configured to provide messages to the WSN Network Server 161. WSN Network Server 161 can be configured to send these messages to WSN Interface Controller 121. WSN Interface Controller 121 can convert these messages into a protocol suitable for transmission over WSN 111. In some embodiments of WSNs, the WSN interface controller has an open interface and can communicate with the Application Entity 151 without the need for WSN Network Server 161.

FIG. 1B depicts an exemplary implementation of IoT applications using MTC devices that directly connect to the cellular network. Consistent with disclosed embodiments, as shown in FIG. 1B, necessary functions performed by WSN Interface Controller 121 in FIG. 1A can be performed additionally or alternatively by Gateway 141. The direct connections shown in FIG. 1B can be implemented using LPWAN technologies and standards that enable MTC devices to send data over the cellular network to components of Cellular Network 131, and/or an application entity service provider (e.g., Application Entity 151). In some aspects, these systems may benefit application entity service providers and cellular network operators. For example, application entity service providers may be freed from the expense of using the WSN (e.g., WSN 111 for FIG. 1A), while the cellular network operator could receive revenue for each MTC device connecting to Cellular Network 131. However, because of the different protocol stacks used by different MTC devices and application entities, such an arrangement may still require an interworking device (e.g., Gateway 141) to handle interworking between Application Entity 151 and Cellular Network 131 for the MTC devices.

Consistent with disclosed embodiments, the interworking depicted in FIG. 1B can be performed using differing protocols at differing levels of the protocol stack. For example, as discussed below, Gateway 141 can be configured to perform interworking functions at the network layer, application layer, device management layer, and DM layer. One of skill in the art would recognize that the following discussion is not intended to be limiting, and that Gateway 141 may be configured to perform interworking functions involving other protocols, and/or involving other protocol levels of the protocol stack.

Network Layer Interworking

In some embodiments, 6LoWPAN provides services up to the network layer for WSNs. But 6LoWPAN uses a modified form of IPv6 addressing, as described in the 6LoWPAN Specifications. According to the system of FIG. 1B, systems and methods using direct connections to Cellular Network 131 may require Gateway 141 (e.g., a 6LoWPAN border router) to interwork between messages from the Application Entity 151 that use IPv6 as the network protocol and messages to the MTC-devices that use 6LoWPAN as the network protocol.

Application Layer Interworking

In some embodiments, MTC devices can be configured to use MQTT-SN to interact with application entities (e.g., Application Entity 151) that are using MQTT, a publish/subscribe messaging protocol using a client/server architecture that can run over non-TCP/IP networks, such as Zigbee or NB-IoT. In such implementations, clients can be MTC devices and the servers (the MQTT brokers) can be the application entities.

As shown in FIG. 1B, MTC devices can be configured to connect directly to Cellular Network 131. However, cellular network operators or application entity service providers may be required to deploy an MQTT-SN gateway (e.g., Gateway 141) to provide functionality otherwise provided by WSN Interface Controller 121. In some embodiments, this Gateway 141 can be configured to provide at least one of copying and forwarding services, protocol interworking, and addressing.

For example, absent interworking device Gateway 141, MQTT-SN clients may be unable to connect with MQTT-SN gateways as described in the MQTT-SN Specifications. Gateways use broadcast messages to advertise their presence on a WSN. However, NB-IoT does not support broadcast messages, preventing use of this gateway discovery procedure. Therefore Gateway 141 must be configured with a substitute for broadcasting over NB-IoT.

As an additional example, Gateway 141 can be configured to handle protocol interworking between messages over MQTT-SN and messages over MQTT, which can be HTTP over TCP/IP. Rather than interworking between WSN 111 and Cellular Network 131, as in FIG. 1A, Gateway 141 would handle interworking between Cellular Network 131 and Application Entity 151.

Furthermore, Gateway 141 can be configured to resolve addressing differences between MQTT-SN addresses and 3GPP connection identifiers. For example, Cellular Network 131 correlates MTC devices with 3GPP connection identifiers, while a MQTT-SN client running on the MTC device can be identified using an MQTT-SN address. Gateway 141 can be configured to enable Cellular Network 131 to understand how to route the message to the correct MTC device across the 3GPP network.

In some embodiments, Gateway 141 may be configured as a transparent MQTT-SN gateway or an aggregating MQTT-SN gateway, as described in the MQTT-SN Specifications. An MQTT-SN gateway can pass messages from the MTC devices (e.g., MTC 101a, MTC 101b, and MTC 101c) to an MQTT broker, such as Application Entity 151, and must translate the messages from the format used by the MTC devices (MQTT-SN format) to the format required by the MQTT broker (MQTT format). The MQTT-SN gateway can be configured to also operate in the reverse direction, changing the format of the messages from the MQTT broker from MQTT format to MQTT-SN format, before the messages are forwarded towards the MTC devices.

Device Management Layer Interworking

In some embodiments, OMA DM and OMA LWM2M are device management protocols that can be used to manage and access devices on a network, which may or may not be a WSN. Both the OMA DM and OMA LWM2M protocols are client/server protocols, in which a client on the MTC device communicates with a server running a management platform, but OMA LWM2M is designed for IoT applications and requires less computing resource requirements than OMA DM. According to the system of FIG. 1B, Gateway 141 can interwork between OMA LWM2M devices and an OMA DM server. In this manner, existing OMA DM infrastructure may be used with OMA LWM2M devices. Likewise OMA DM devices could be used with OMA LWM2M servers. In part, this gateway could serve as a protocol converter, and would be adapted to convert between HTTP (used by OMA DM) and CoAP (used by OMA LWM2M). Application Entity 151 could then use either the DM or LWM2M device management protocols, and Gateway 141 would convert to the protocol required by the MTC device (either DM or LWM2M).

DM Layer Interworking

In some embodiments, one or more applications, such as Application Entity 151, may communicate with a device management server, such as an OMA DM or OMA LWM2M server, according to a DM layer protocol. This DM server may then communicate with MTC devices. In this manner, the DM server may be shared over multiple applications. In some embodiments, the DM server and the application entity may have different service providers, while in some embodiments the DM server and the application entity may have the same service provider.

According to the system of FIG. 1B, Gateway 141 may be configured as a DM server. Application Entity 151 may be configured to communicate with interworking device Gateway 141. Based on this communication, interworking device Gateway 141, acting as a DM server, can send messages to and/or receive messages from MTC devices (e.g., MTC Device 101a, MTC Device 101b, and MTC Device 101c) using at least one of OMA DM and OMA LWM2M, depending on whether the MTC devices include OMA DM and OMA LWM2M devices.

As shown, Gateway 141 can be configured to perform multiple different interworking functions at the network layer, application layer, device management layer, and/or the DM layer. As would be appreciated by one of skill in the art, these functions may be performed by a single device, or they may be performed by multiple devices. For example, Gateway 141 may comprise a DM server that receives a message from an application entity and generates an OMA DM message. Another component of Gateway 141 may be configured to receive the OMA DM message and convert it to an OMA LWM2M message over CoAP.

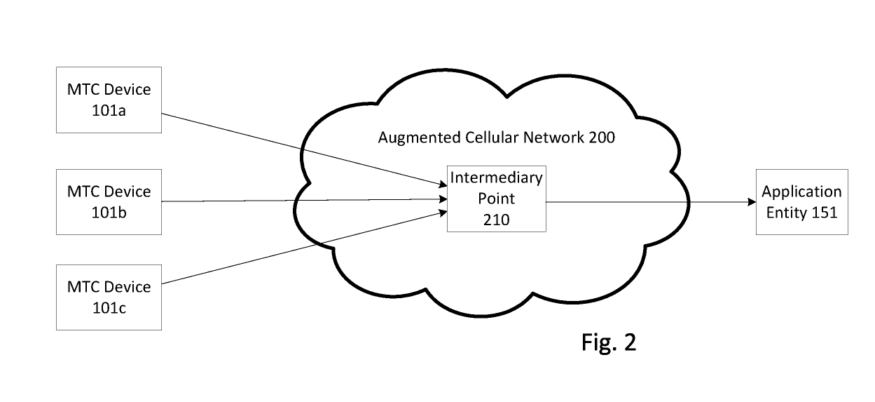

FIG. 2 depicts an exemplary functional schematic of MTC devices directly connected to Augmented Cellular Network 200. The MTC devices can be connected to Augmented Cellular Network 200 using low-power wide-area modems. Consistent with disclosed embodiments, Augmented Cellular Network 200 can be a cellular network including an intermediary point that performs additional interworking functions consistent with disclosed embodiments. As shown, the MTC devices (e.g., MTC Device 110a, MTC Device 110b, and MTC Device 110c) can be configured to communicate with an intermediary point (e.g., Intermediary Point 210) within Augmented Cellular Network 200. Unlike the systems depicted in FIG. 1A and FIG. 1B, neither an additional WSN interface controller nor an additional interworking device gateway need be placed between the MTC devices and Application Entity 151. Instead, in some embodiments, Intermediary Point 210 can provide at least some of the functionality provided by WSN Interface Controller 121 and interworking device Gateway 141.

Intermediary Point 210 can be implemented using a variety of network components. These network components can interoperate to provide the functionality described herein, or this functionality can be provided using a single network component. In some embodiments, these network components can include at least one of a PGW, a C-SGN that may include some PGW functionality, and an SCEF, having at least the functionality described in the 3GPP Specifications. These network components can be realized as virtual network functions, as would be appreciated by one of skill in the art.

The system depicted in FIG. 2 can be considered to improve upon the systems depicted in FIGS. 1A and 1B. For example, unlike the system depicted in FIG. 1A, WSN interface controllers are not required. Instead, the intermediary point acts as the necessary portion of a WSN interface controller, enabling the MTC devices to connect directly to Augmented Cellular Network 200. But unlike the system depicted in FIG. 1B, operators of cellular networks or application entity service providers need not provide separate interworking device gateways, as Intermediary Point 210 can also be configured to act as a gateway providing the necessary interworking functionality. For example, as described in greater detail below, Intermediary Point 210 can be configured to offer built-in broadcasting capabilities, addressing capabilities, interface control, and interworking capabilities for LPWAN devices.

As would be appreciated by one of skill in the art, such addressing and interworking capabilities are not restricted to LPWAN technologies or device management protocols. In this manner, by augmenting Cellular Network 131 with Intermediary Point 210, cellular network operators can enable MTC devices to communicate directly with Augmented Cellular Network 200, or eliminate WSN Interface Controller 121 and upgrade existing MTC devices to communicate directly with Augmented Cellular Network 200, without having to install interworking device Gateway 141 of FIG. 1B. This makes deploying LPWAN MTC devices simpler and less expensive. In this manner, the disclosed embodiments provide a technical solution to technical problems arising in the context of cellular communications.

Intermediary Point 210 can be configured to provide broadcasting capabilities to Cellular Network 131, consistent with disclosed embodiments. Intermediary Point 210 can be configured to manage Access Point Names (APNs) that define the scope of broadcast domains. As would be appreciated by one of ordinary skill in the art, an APN can be associated with a set of MTC devices and application entity that are to communicate. When an MTC device establishes a connection to Intermediary Point 210, the APN is supplied as part of the connection messaging of both the T6 interface and GTP interface. As described in the 3GPP Specifications, when connections for MTC devices are between an SCEF and one of MME, Serving GPRS Support Node (SGSN) or C-SGN, the T6 interface is used. As described in the 3GPP Specifications, when connections for MTC devices are between a PGW and SGW, or between a Gateway GPRS Support Node (GGSN) and an SGSN, the GTP interface is used. Intermediary Point 210 may either be configured with the APN of the Application Entity 151, or Application Entity 151 may supply the APN as part of its registration/configuration messaging with Intermediary Point 210. When broadcast messages are provided, either by Application Entity 151 or by an MTC device (e.g., MTC Device 101a), Intermediary Point 210 can replicate these messages and provide them to all of the entities associated with the APN.

Intermediary Point 210 can be configured to selectively broadcast messages to entities of the APN, consistent with disclosed embodiments. For example Intermediary Point 210 can be configured to determine recipients based on the contents of the protocol messages. For example, in MQTT-SN, MTC devices can send SEARCHGW broadcasts. Intermediary Point 210 can be configured to store an association between an identifier of that MTC device and its sending of the SEARCHGW broadcast. When Application Entity 151 sends a GWINFO response as a broadcast, Intermediary Point 210 can be configured to copy and forward this response based on the stored associations. For example, Intermediary Point 210 can send the GWINFO response to each MTC device that provided a SEARCHGW broadcast. As would be appreciated by one of skill in the art, such copying and forwarding enables proper functioning of the MQTT-SN Gateway Discovery procedure, so that MTC devices can discover MQTT-SN gateway(s).

Intermediary Point 210 can be configured to provision MTC devices with information necessary to communicate with Application Entity 151, consistent with disclosed embodiments. For example, when using MQTT-SN, the MTC device needs to know the identity of the MQTT-SN gateway, and may issue a SEARCHGW broadcast to elicit responses from MQTT-SN gateways. Alternatively, Intermediary Point 210 can be configured to provide the identity of the MQTT-SN gateway to the MTC device using enhancements to the 3GPP protocols when the MTC device connects to Augmented Cellular Network 200, thereby eliminating the need for the MTC device to issue a SEARCHGW broadcast. One of skill in the art would recognize that similar information can be provided for other LPWAN protocols.

Intermediary Point 210 can provision MTC devices when the MTC devices attempt to connect to the Augmented Cellular Network 200, consistent with disclosed embodiments. In some aspects, the Augmented Cellular Network 200 can be configured to provide the provisioning information using the T6 interface or GTP interface. Intermediary Point 210 can use the T6 interface and/or the GTP interface to provide an MQTT-SN gateway identifier of the gateway. Specifically, the MQTT-SN gateway identifier can be passed in the T6 interface by creating a field for “Identifier of MQTT-SN gateway” in the Extended Protocol Configuration Options (Extended-PCOs) portion of the T6 interface messages. When the GTP interface is used, the created field for “Identifier of MQTT-SN gateway” could be in the Protocol Configuration Options (PCOs) portion of the GTP messages.

Additionally or alternatively, Intermediary Point 210 can be configured to provide built-in address translation capabilities to Augmented Cellular Network 200, consistent with disclosed embodiments. As would be recognized by one of skill in the art, different networks, such as WSN networks and 3GPP networks, can use different addressing formats. For example, a 6LoWPAN network can use a compressed IPv6 header, while a 3GPP network can use a Mobile Subscriber ISDN (MSISDN). In some embodiments, an MTC device can be associated with a 3GPP address (e.g., an identifier of a 3GPP connection to reach the MTC device) and a WSN address (e.g. a 6LoWPAN address). When the MTC device establishes a connection to Intermediary Point 210, Intermediary Point 210 can save its identifier of that connection as the 3GPP address of that MTC device.

In one embodiment, Intermediary Point 210 can receive a WSN address of an MTC device (e.g., MTC Device 101a) when the MTC device explicitly supplies its WSN address as part of the connection establishment messaging. For example, the WSN device address can be passed as part of the connection establishment messaging when using the T6 interface used for connection establishment. As a non-limiting example, the connection establishment messaging can be configured to include a field for “WSN device address.” This field can be included in the Extended Protocol Configuration Options (Extended-PCOs) portion of the T6 interface messages. Additionally or alternatively, the WSN device address can be passed using the GTP interface. As a non-limiting example, GTP messages can be configured to include a field for “WSN device address.” This field can be included among the Protocol Configuration Options (PCOs).

In another embodiment, Intermediary Point 210 can receive a WSN address of an MTC device (e.g., MTC Device 101a) by analyzing the first message sent by the MTC device. Intermediary point 210 can be configured to extract the MTC device's address from this message. For example, for an MTC device using the MQTT-SN protocol, the clientID of the MTC device can be extracted from the MTC device's first message.

Intermediary Point 210 can convert addresses in messages received from the MTC devices and/or Application Entity 151 into another addressing format. For example, when Intermediary Point 210 receives a message with a WSN address from Application Entity 151, Intermediary Point 210 can determine the proper 3GPP address and forward the message to that address. In some embodiments, Intermediary Point 210 can accomplish this conversion by storing an association between the 3GPP address and the WSN address. This association can be used to determine the appropriate WSN address or 3GPP address.

By examining the addresses in the messages received, Intermediary Point 210 can associate the non-3GPP address of an MTC device with a 3GPP address. The Augmented Cellular Network 200 can use this 3GPP address to route the message from the intermediary point to the MTC device. This allows messages from Application Entity 151 sent to an MTC device's non-3GPP address to be forwarded by Intermediary Point 210 to the MTC device.

Intermediary Point 210 can also be configured to serve as an interface controller, similar to WSN Interface Controller 121. In some embodiments, Intermediary Point 210 can be configured to perform the WSN interface controller functions described above with regard to FIG. 1B. For example, when the MTC devices connecting to Intermediary Point 210 use 6LoWPAN, Intermediary Point 210 can serve as a 6LoWPAN border router. In that example, Intermediary Point 210 can receive standard IPv6 packets from Application Entity 151 and convert the standard IPv6 packets into 6LoWPAN format. Intermediary Point 210 could then forward the converted packets to the addressed MTC device. In this manner, Intermediary Point 210 can enable a cellular network operator or service provider to avoid deploying a stand-alone interface controller.

Intermediary Point 210 can also be configured to serve as an interworking device, similar to interworking device Gateway 141. Intermediary Point 210 can be configured to serve as an OMA LWM2M adapter and/or an OMA DM adaptor, consistent with disclosed embodiments. For example, Intermediary Point 210 can be configured to convert an OMA DM HTTP payload to OMA LWM2M CoAP payload. In this manner, Intermediary Point 210 can enable OMA DM servers to manage and access MTC devices supporting OMA LWM2M protocols. Intermediary Point 210 can also enable OMA LWM2M servers to manage and access MTC devices supporting OMA DM. This interoperability benefits service providers already running either DM or LWM2M servers. Additionally or alternatively, Intermediary Point 210 can be configured to expose a DM Layer interface. In such embodiments, Intermediary Point 210 can be configured to serve as an OMA DM server and/or an OMA LWM2M server. In such embodiments, Application Entity 151 can use the DM Layer interface to access the OMA DM server and/or OMA LWM2M server functionality. In this manner, the cellular network operator can offer device management functionality to application entity service providers lacking dedicated OMA DM servers or OMA LWM2M servers.

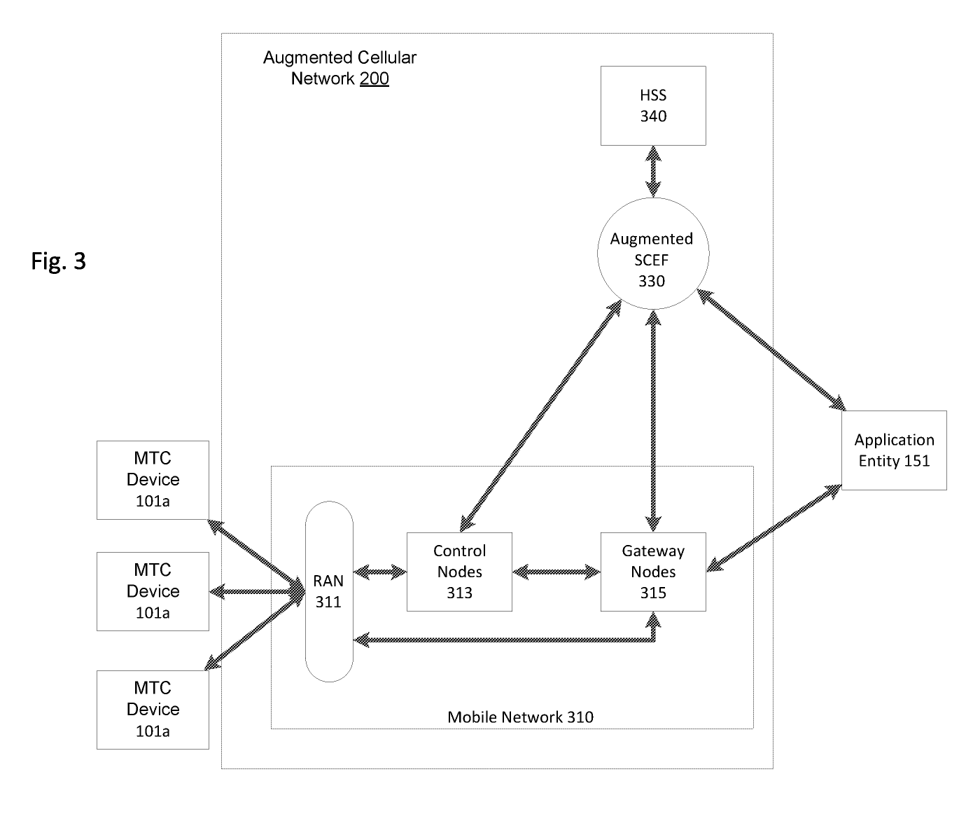

FIG. 3 depicts an exemplary schematic of Augmented Cellular Network 200, consistent with disclosed embodiments. MTC devices (e.g., MTC device 110a, 110b, and 110c) can use Augmented Cellular Network 200 to communicate with an application entity (e.g., Application Entity 151) over Mobile Network 310. Augmented Cellular Network 200 can include a control plane that conveys data for configuring the connection between Application Entity 151 and MTC devices, a user plane that supports connections between Application Entity 151 and MTC devices, and components that enable interworking with other networks.

As described above, the MTC devices (e.g., MTC device 110a, 110b, and 110c) can be termination points for machine-type communication, such as embedded devices, vehicles, mobile devices, or similar devices configured to automatically provide contextual information, such as location and device state. These examples are not intended to be limiting.

Likewise, Application Entity 151 can be a termination point for machine type communications. Application Entity 151 need not comprise a single operator, device, component, or system. For example, Application Entity 151 can encompass one or more of a Service Capability Server (SCS), as described in the 3GPP Specifications, and a termination point for machine-type communications. In some embodiments, multiple application entities can provide information to Augmented Cellular Network 200. For example, a first application entity can include an SCS providing instructions to Augmented Cellular Network 200 based on requests from a first termination point, while a second application entity can include a second termination point that provides requests to Augmented Cellular Network 200.

Mobile Network 310 can enable the MTC devices to communicate with Application Entity 151. Such communication is mediated by components of Mobile Network 310. These components can include Control Nodes 313, Gateway Nodes 315, and Radio Access Network (RAN) 311. Augmented Cellular Network 200 can support various communications pathways between Application Entity 151 and the MTC devices, as described in the 3GPP Specifications. For example, Augmented Cellular Network 200 can support a direct communication pathway from Application Entity 151 to the MTC devices through Gateway Nodes 315 and RAN 311. Augmented Cellular Network 200 can also support an indirect communication pathway from Application Entity 151 to the MTC devices through Augmented SCEF 330, Control Nodes 313, and RAN 311. Augmented Cellular Network 200 can further support hybrid communications using both the direct and indirect pathways.

RAN 311 can manage interaction between the MTC devices and the remainder of Augmented Cellular Network 200. RAN 311 can include transceivers for communicating with the MTC devices, and can include controllers for managing the transceivers. RAN 125 can include one or more of a Base Transceiver Station, a Node B, and/or an eNodeB, with at least such capabilities and functions as described in the 3GPP Specifications.

Control Nodes 313 may serve as interfaces between Gateway Nodes 315 and RAN 311. Control Nodes 313 may comprise nodes responsible for one or more of paging MTC devices, authenticating a user or user device, mobility management, location registration, bearer creation and destruction, and selection of one or more of Gateway Nodes 315 towards a fixed network, such as a packet data network (as a non-limiting example, the internet or an SIP-based IMS network). Each of Control Nodes 313 may correspond to a geographic area. In some embodiments, Control Nodes 313 may comprise one or more of a Mobile Switching Center (MSC), C-SGN, MME, and SGSN, with at least such capabilities and functions as described in the 3GPP Specifications and known to one of skill in the art.

Gateway Nodes 315 can convey data from the MTC devices to Application Entity 151, consistent with disclosed embodiments. Gateway Nodes 315 can receive data from at least one of RAN 311 and Control Nodes 313. One or more of Gateway Nodes 315 can be configured as a mobility anchor to support handovers as MTC devices move between networks or between regions of mobile network 310. As a non-limiting example, a region may comprise one or more of a cell associated with a single eNodeB, a tracking area associated with multiple eNodeBs, an MME pool area associated with one or more MMEs, a SGW service area, and an HPLMN, or similar logical division of Mobile Network 310. As would be recognized by one of skill in the art, regions may comprise other logical divisions of a mobile network. As a further non-limiting example, a region may comprise one or more of a city, state, country, territory, and component thereof. Gateway Nodes 315 can allocate IP addresses to MTC devices for access through the fixed network, consistent with disclosed embodiments. These IP addresses can be determined by at least one of Gateway Nodes 315. In some embodiments, Gateway Nodes 315 can include at least one of a GGSN, and PGW, with at least such capabilities and functions as described in the 3GPP Specifications.

A machine-type communication node (SCEF 330) can manage machine-type communications between the MTC devices and Application Entity 151, consistent with disclosed embodiments. Augmented SCEF 330 can be implemented as a virtual network function, and can be implemented on one or more servers. For example, Augmented SCEF 330 may be implemented on a cloud computing system, as would be recognized by one of ordinary skill in the art. Augmented SCEF 330 can provide the functionality of a SCEF, with at least the capabilities and functions described in the 3GPP Specifications, consistent with disclosed embodiments. Augmented SCEF 330 can interoperate with a subscriber information node, such as an external HSS/HLR, Subscription Profile Repository, or User Data Repository, as described in the 3GPP Specifications. Augmented SCEF 330 can manage requests concerning machine-type communications from Application Entity 151, consistent with disclosed embodiments. Augmented SCEF 330 can receive messages, such as device trigger requests, and route these messages to appropriate Control Nodes 313 of Mobile Network 310.

Augmented SCEF 330 can provide the functionality of an SCS, consistent with disclosed embodiments. For example, Augmented SCEF 330 may be configured to provide standardized application programming interfaces towards Application Entity 151. In certain aspects, these application program interfaces may be configured as web services. Such web services may be designed according to REST principles as would be understood by one of skill in the art. Augmented SCEF 330 can also be configured to handle one or more security functions, such as authentication, authorization, and/or encryption, for communications between Augmented Cellular Network 200 and Application Entity 151.

HSS 340 can store subscription-related information for use by other components of Augmented Cellular Network 200 for handling calls and/or data sessions, consistent with disclosed embodiments. For example, HSS 340 may handle MTC device identification, numbering and addressing information; network access control information for authentication and authorization; user location control information; and profile information. In some embodiments, HSS 340 may be configured to translate an external identifier of an MTC device into an internal identifier specific to Augmented Cellular Network 200. For example, HSS 340 may be configured to accept a URI, such as an SIP address. As another example, HSS 340 may be configured to provide or use an International Mobile Subscriber Identity (or IMSI). As an additional example, HSS 340 can store APN information, or addressing information for MTC devices. HSS 340 can also store current MTC device serving node information. In some embodiments, the functions provided by HSS 340 can additionally or alternatively be provided by Augmented SCEF 330. For example, the storage of subscription-related information, device identification, network access control, APN information, addressing information, and profile information can be managed by Augmented SCEF 330.

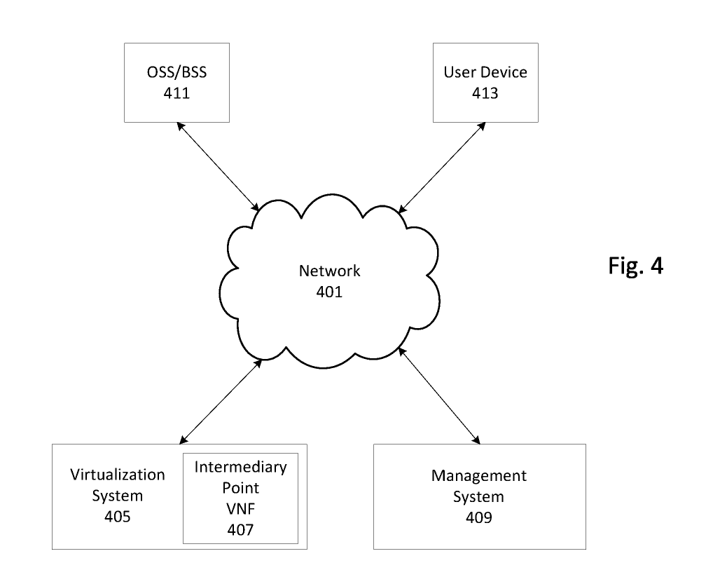

FIG. 4 depicts an exemplary realization of an intermediary point, such as Intermediary Point 210, consistent with disclosed embodiments. In some embodiments, Intermediary Point 210 may be realized as one or more virtual network functions, such as Intermediary Point VNF 407. In some embodiments, Intermediary Point VNF 407 may be hosted on Virtualization System 405. In certain aspects, Intermediary Point VNF 407 may implement modules for common services, management services, storage services, transaction services, and de-multiplexing services. These services may together implement the tasks of Intermediary Point VNF 407, such as handling communication between Intermediary Point VNF 407 and other network entities, managing subscriber communications, and handling data packets received by Intermediary Point VNF 407. Virtualization System 405 may be hosted on a cloud computing platform comprising at least one server according to methods known to one of skill in the art. Exemplary cloud computing platform may include OpenStack™, VMware®, and Titanium™, or similar systems, each of which may be configured to provide suitable platform services for Virtualization System 405, as would be recognized by one of skill in the art.

Consistent with disclosed embodiments, Intermediary Point 210 may comprise one or more instances of Intermediary Point VNF 407, together with Management System 409. In some embodiments, each instance of Intermediary Point VNF 407, and Management System 409, may comprise separate tenants on one or more cloud computing platforms. Management System 409 may comprise an Enterprise Management System (EMS), and may be configured to provide management interfaces for interacting with, controlling, and managing instances of Intermediary Point VNF 407. Management System 409 may be configured to expose a web service interface for interactions with OSS/BSS 411 over Network 401. OSS/BSS 411 may comprise an Operation Support System (OSS) and Business Support System (BSS) with such functionality and structure as would be recognized by one of skill in the art. Management System 409 may be configured to provide access to user devices, such as User Device 413, through a web browser over Network 401. User Device 413 may comprise a workstation, desktop, laptop, tablet, smartphone, or similar device capable of accessing Management System 409 using a web browser. Network 410 may be any type of network (including infrastructure) that provides communications, exchanges information, and/or facilitates the exchange of information. For example, Network 410 may comprise one or more Local Area Networks, Wide Area Networks, virtual networks that extend a private network over a public network, such as VPN, or other suitable connection(s).

The components depicted in FIG. 4 (e.g., Virtualization System 405, Management System 409, User Device 413, and OSS/BSS 411) can be realized using one or more computing systems, consistent with disclosed embodiments. Such computing systems can include parts such as processors, computing memories, displays, I/O interface(s), and network adapters. The processors can be microprocessors, central processing units, or graphics processing units performing various methods in accordance with disclosed embodiments. Such processors can include single core or multi-core processors. The computing memories may include one or more computer hard disks, random access memory, removable storage, or remote computer storage. In various embodiments, the computing memories can store various software programs executed by the processors. The displays can include any device which provides a visual output, for example, a computer monitor, an LCD screen, etc. The I/O interfaces can include keyboards, computer mice, audio input devices, touch screens, or similar human interface devices. A network adapter can include hardware and/or a combination of hardware and software for enabling the computing systems to exchange information with using networks. For example, the network adapters can include Wireless Wide Area Network (WWAN) adapters, Bluetooth modules, near field communication modules, and Local Area Network (LAN) adapters. These parts may communicate with each other via bus, or wirelessly. In some embodiments, such computing systems may include additional parts, or may include fewer parts. As a non-limiting example, such computing systems may not include at least one of a display, I/O interface(s), and network adapters.

Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, or CD-ROM, or other forms of RAM or ROM. Accordingly, the disclosed embodiments are not limited to the above described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A system for managing machine-type communication, comprising:
a cellular network comprising an intermediary point for communication with an application entity and machine-type communication (MTC) devices, wherein the intermediary point performs operations of:
receiving a request to connect to the cellular network from an MTC device.
retrieving connection information for low-power wide-area MTC devices from a non-transitory memory of the cellular network; and
providing the connection information to the MTC device.

2. The system of claim 1, wherein the MTC devices connect using NarrowBand IOT, and wherein the MTC devices use at least one of Message Queue Telemetry Transport for Sensor Networks (MQTT-SN) and IPv6 over Low power Wireless Personal Area Networks (6LoWPAN).

3. The system of claim 1, wherein providing the connection information to the MTC device comprises conveying the connection information from a service capability exposure function (SCEF) to a mobility management entity (MME) using a T6 protocol.

4. The system of claim 1, wherein providing the connection information to the first MTC device comprises conveying the connection information from an SCEF to a service general packet radio service support node (SGSN) using a T6 protocol.

5. The system of claim 1, wherein providing the connection information to the first MTC device comprises conveying the connection information from a service capability exposure function to a cellular IoT serving gateway node (C-SGN) using a T6 protocol.

6. The system of claim 1, wherein providing the connection information to the first MTC device comprises conveying the connection information from a packet data network gateway node (PGW) to a service general packet radio service support node (SGW) using a general packet radio service tunneling protocol (GTP).

7. The system of claim 1, wherein providing the connection information to the first MTC device comprises conveying the connection information using GTP from a node configured to provide PGW and SGW functionality.

8. The system of claim 1, wherein providing the connection information to the first MTC device comprises conveying the connection information from a gateway general packet radio service support node (GGSN) to a service general packet radio service support node (SGSN) using GTP.

9. A system for managing machine-type communication, comprising:
a cellular network including an intermediary point configured to communicate with an application entity and machine-type communication (MTC) devices, and
wherein the intermediary point serves as an interface controller for converting formats in messages between the application entity and the cellular network.

10. The system of claim 9, wherein the MTC devices are configured to communicate using 6LoWPAN and wherein the intermediary point is configured to act as a 6LoWPAN border router for the MTC devices.

11. The system of claim 9, wherein the MTC devices are configured to communicate using MQTT-SN, and wherein the intermediary point is configured to act as a transparent MQTT-SN gateway or an aggregating MQTT-SN gateway for the MTC devices.

12. The system of claim 9, wherein the intermediary point performs copying and forwarding of messages received from the application entity or the MTC devices to enable broadcast communication between the application entity and the MTC devices.

13. The system of claim 9, wherein the intermediary point is implemented by a node that performs the functions of at least one of a PGW, C-SGN, and SCEF.

14. A system for managing machine-type communication, comprising
a cellular network that includes an intermediary point configured to communicate with an application entity and machine-type communication (MTC) devices, and
wherein the intermediary point serves as an interworking node for device management.

15. The system of claim 14, wherein the intermediary point is configured to receive one or more messages in OMA DM running over HTTP from the application entity, convert the received messages into messages in OMA LWM2M running over CoAP, and send the converted messages to one or more MTC devices.

16. The system of claim 14, wherein the intermediary point is configured to receive one or more messages in OMA DM running over HTTP from one or more MTC devices, convert the received messages into messages in OMA LWM2M running over CoAP, and send the converted messages to the application entity.

17. The system of claim 14, wherein the intermediary point is configured to receive one or more messages in OMA LWM2M running over CoAP from the application entity, convert the received messages into messages in OMA DM running over HTTP, and send the converted messages to one or more MTC devices.

18. The system of claim 14, wherein the intermediary point is configured to receive one or more messages in OMA LWM2M running over CoAP from one or more MTC devices, convert the received messages into messages in OMA DM running over HTTP, and send the converted messages to the application entity.

19. The system of claim 14, wherein the intermediary point is configured to serve as a device management server, the device management server comprising at least one of a OMA DM server and an OMA LWM2M server.

20. The system of claim 19, wherein the intermediary point is configured to expose a device management layer to the application entity for accessing the functionality of the device management server.

21. The system of claim 14, wherein the intermediary point is implemented by a node that performs the functions of at least one of a PGW, C-SGN, and SCEF.

22. A system for managing machine-type communication, comprising
a cellular network that includes an intermediary point configured to communicate with an application entity and machine-type communication (MTC) devices, and
wherein the intermediary point is configured to receive messages from the application entity, use the first addresses in the messages to determine second addresses, and route the messages to the MTC devices according to the second addresses.

23. The system of claim 22, wherein the first addresses comprise addresses of the MTC devices known to the application entity and the second addresses comprise identifiers of cellular network connections to reach the MTC devices.

24. The system of claim 22, wherein the intermediary point uses the first addresses to determine the second addresses using stored associations between the first addresses and the second addresses.

25. The system of claim 22, wherein at least one of a T6 interface of the cellular network and GTP of the cellular network provides cellular network connections to reach the MTC devices.

26. The system of claim 22, wherein the intermediary point determines the second address by performing protocol analysis of the messages from the MTC devices on the cellular network connections.

27. The system of claim 22, wherein the intermediary point is implemented by a node that performs the functions of at least one of a PGW, C-SGN, and SCEF.
